(19) United States
(12) Patent Application Publication
(10) Pub. No.: US 2017/0055193 A1
(43) Pub. Date: Feb. 23, 2017

(54) COMMUNICATION DEVICE AND METHOD FOR COMMUNICATING USING A FREQUENCY RANGE

(71) Applicant: Intel Corporation, Santa Clara, CA (US)

(72) Inventors: MARKUS DOMINIK MUECK, Neubiberg (DE); YING HE, Sydney (AU); BEESHANGA JAYAWICKRAMA, Sydney (AU); ERYK DUTKIEWICZ, Figtree (AU); CHRISTIAN DREWES, Germering (DE)

(21) Appl. No.: 14/828,537

(22) Filed: Aug. 18, 2015

(51) Int. Cl. H04W 36/14

(52) U.S. Cl. CPC H04W 36/14; H04W 88/06

(57) ABSTRACT

A communication device is described comprising a transceiver configured for communication according to a wide area network radio access technology and configured for communication according to a local area network radio access technology, a detector configured to detect whether a frequency range is unoccupied and a controller configured to control the transceiver to, if the frequency range is unoccupied, transmit data according to the local area network radio access technology to occupy the frequency range until a communication starting time according to a frame structure of the wide area network radio access technology and to control the transceiver to start communication using the frequency range according to the wide area network radio access technology at the communication starting time.

### TECHNICAL FIELD

Embodiments described herein generally relate to communication devices and methods for communicating using a frequency range.

### BACKGROUND

In view of the increasing load of cellular communication networks, it has been proposed to let cellular communication networks use unlicensed spectrum. For example, for LTE (Long Term Evolution), LTE-LAA (Licensed Assisted Access) and LTE-U (LTE in unlicensed spectrum) has been proposed for the use of 4G LTE communication in unlicensed spectrum such as the 5 GHz band used by dual-band WiFi devices. Efficient approaches for the usage of a frequency range in unlicensed spectrum for communication are desirable.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various aspects are described with reference to the following drawings, in which:

FIG. 1 shows a communication system, for example according to 3GPP.

FIG. 2 shows a frame of an exemplary frame structure.

FIG. 3 shows a communication arrangement.

FIG. 4 illustrates LSA for spectrum management.

FIG. 5 illustrates SAS for spectrum management.

FIG. 6 shows a communication device occupying a frequency range by means of a wide area network radio access technology for a communication by means of a local area network radio access technology.

FIG. 7 shows a flow diagram illustrating a method for communicating using a frequency range.

FIG. 8 shows a communication device reserving a frequency range by means of a first radio access technology for a communication by means of a second radio access technology.

FIG. 9 shows a communication device moving a communication from a frequency range to ISM band when the frequency range is started being used.

FIG. 10 shows an LSA offloading procedure.

FIG. 11 illustrates a transmission process of the LSA offloading procedure of FIG. 8.

FIG. 12 shows the channel moving process from LSA band to unlicensed band during a band moving time in more detail.

FIG. 13 illustrates a coexistence mechanism which is based on a clear channel assessment and a following WiFi transmission by the LTE radio communication network.

FIG. 14 illustrates a coexistence mechanism which is based on a clear channel assessment (CCA) and a following WiFi transmission performed by the UE.

FIG. 15 illustrates a coexistence mechanism which is based on a clear channel assessment and a clear to send message by the base station.

FIG. 16 illustrates a coexistence mechanism which is based on a clear channel assessment and a request to send message by the UE followed by a clear to send message by the base station.

FIG. 17 illustrates a further coexistence mechanism which is based on a clear channel assessment and a request to send message by the UE followed by a clear to send message by the base station.

### DESCRIPTION OF EMBODIMENTS

The following detailed description refers to the accompanying drawings that show, by way of illustration, specific details and aspects of this disclosure in which the invention may be practiced. Other aspects may be utilized and structural, logical, and electrical changes may be made without departing from the scope of the invention. The various aspects of this disclosure are not necessarily mutually exclusive, as some aspects of this disclosure can be combined with one or more other aspects of this disclosure to form new aspects.

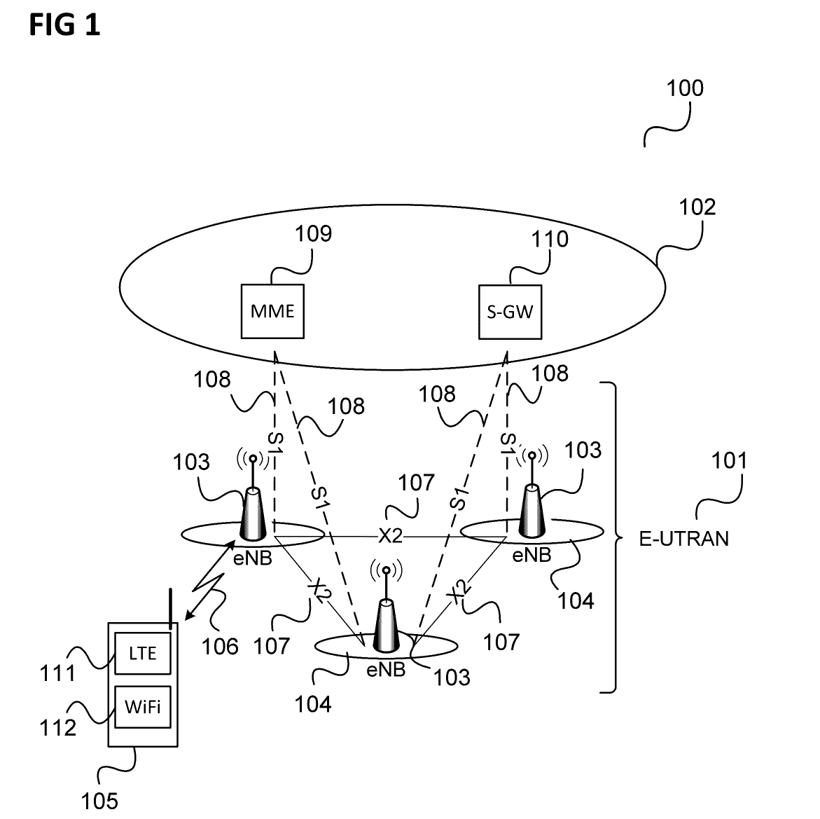

FIG. 1 shows a communication system 100, for example according to 3GPP (Third Generation Partnership Project).

The communication system 100 may be a cellular mobile communication system (also referred to as cellular radio communication network in the following) including a radio access network (e.g. an E-UTRAN, Evolved UMTS (Universal Mobile Communications System) Terrestrial Radio Access Network according to LTE (Long Term Evolution), or LTE-Advanced) 101 and a core network (e.g. an EPC, Evolved Packet Core, according LTE, or LTE-Advanced) 102. The radio access network 101 may include base stations (e.g. base transceiver stations, eNodeBs, eNBs, home base stations, Home eNodeBs, HeNBs according to LTE, or LTE-Advanced or Small Cell eNodeBs) 103. Each base station 103 may provide radio coverage for one or more mobile radio cells 104 of the radio access network 101. In other words: The base stations 103 of the radio access network 101 may span different types of cells 104 (e.g. macro cells, femto cells, pico cells, small cells, open cells, closed subscriber group cells, hybrid cells, for instance according to LTE, or LTE-Advanced). It should be noted that examples described in the following may also be applied to other communication networks than LTE communication networks, e.g. communication networks according to UMTS, GSM (Global System for Mobile Communications), WIFI etc.

Wireless Standards for which LSA/SAS Technology and the examples described in the following can be employed for example include: cellular wide area radio communication technology (which may include e.g. 5^{th} Generation (5G) communication systems, a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology (e.g. UMTS (Universal Mobile Telecommunications System), FOMA (Freedom of Multimedia Access), 3GPP LTE (Long Term Evolution), 3GPP LTE Advanced (Long Term Evolution Advanced)), CDMA2000 (Code division multiple access 2000), CDPD (Cellular Digital Packet Data), Mobitex, 3G (Third Generation), CSD (Circuit Switched Data), HSCSD (High-Speed Circuit-Switched Data), UMTS (3G) (Universal Mobile Telecommunications System (Third Generation)), W-CDMA (UMTS) (Wideband Code Division Multiple Access (Universal Mobile Telecommunications System)), HSPA (High Speed Packet Access), HSDPA (High-Speed Downlink Packet Access), HSUPA (High-Speed Uplink Packet Access), HSPA+(High Speed Packet Access Plus), UMTS-TDD (Universal Mobile Telecommunications System-Time-Division Duplex), TD-CDMA (Time Division-Code Division Multiple Access), TD-CDMA (Time Division-Synchronous Code Division Multiple Access), 3GPP Rel. 8 (Pre-4G) (3rd Generation Partnership Project Release 8 (Pre-4th Generation)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 12), 3GPP Rel. 14 (3rd Generation Partnership Project Release 12), 3GPP LTE Extra, LTE Licensed-Assisted Access (LAA), UTRA (UMTS Terrestrial Radio Access), E-UTRA (Evolved UMTS Terrestrial Radio Access), LTE Advanced (4G) (Long Term Evolution Advanced (4th Generation)), cdmaOne (2G), CDMA2000 (3G) (Code division multiple access 2000 (Third generation)), EV-DO (Evolution-Data Optimized or Evolution-Data Only), AMPS (1G) (Advanced Mobile Phone System (1st Generation)), TACS/ETACS (Total Access Communication System/Extended Total Access Communication System), D-AMPS (2G) (Digital AMPS (2nd Generation)), PTT (Push-to-talk), MTS (Mobile Telephone System), IMTS (Improved Mobile Telephone System), AMTS (Advanced Mobile Telephone System), OLT (Norwegian for Offentlig Landmobil Telefoni, Public Land Mobile Telephony), MTD (Swedish abbreviation for Mobiltelefonisystem D, or Mobile telephony system D), Autotel/PALM (Public Automated Land Mobile), ARP (Finnish for Autoradiopuhelin, “car radio phone”), NMT (Nordic Mobile Telephony), Hicap (High capacity version of NTT (Nippon Telegraph and Telephone)), CDPD (Cellular Digital Packet Data), Mobitex, DataTAC, iDEN (Integrated Digital Enhanced Network), PDC (Personal Digital Cellular), CSD (Circuit Switched Data), PHS (Personal Handy-phone System), WiDEN (Wideband Integrated Digital Enhanced Network), iBurst, Unlicensed Mobile Access (UMA, also referred to as also referred to as 3GPP Generic Access Network, or GAN standard)), Wireless Gigabit Alliance (WiGig) standard, mmWave standards in general (wireless systems operating at 10-90 GHz and above such as WiGig, IEEE 802.11ad, IEEE 802.11ay, etc.), etc.]

A mobile terminal (e.g. a UE) 105 located in a mobile radio cell 104 may communicate with the core network 102 and with other mobile terminals via the base station 103 providing coverage in (in other words operating) the mobile radio cell 104. In other words, the base station 103 operating the mobile radio cell 104 in which the mobile terminal 105 is located may provide the E-UTRA user plane terminations including the PDCP (Packet Data Convergence Protocol) layer, the RLC (Radio Link Control) layer and the MAC (Medium Access Control) layer and control plane terminations including the RRC (Radio Resource Control) layer towards the mobile terminal 105.

Control and user data may be transmitted between a base station 103 and a mobile terminal 105 located in the mobile radio cell 104 operated by the base station 103 over the air interface 106 on the basis of a multiple access method. On the mobile communication standard air interface, such as LTE air interface 106 different duplex methods, such as FDD (Frequency Division Duplex) or TDD (Time Division Duplex), may be deployed.

The base stations 103 are interconnected with each other by means of a first interface 107, e.g. an X2 interface. The base stations 103 are also connected by means of a second interface 108, e.g. an S1 interface, to the core network 102, e.g. to an MME (Mobility Management Entity) 109 via an S1-MME interface 108 and to a Serving Gateway (S-GW) 110 by means of an S1-U interface 108. The S1 interface 108 supports a many-to-many relation between MMEs/S-GWs 109, 110 and the base stations 103, i.e. a base station 103 may be connected to more than one MME/S-GW 109, 110 and an MME/S-GW 109, 110 may be connected to more than one base station 103. This may enable network sharing in LTE.

For example, the MME 109 may be responsible for controlling the mobility of mobile terminals located in the coverage area of E-UTRAN, while the S-GW 110 may be responsible for handling the transmission of user data between mobile terminals 105 and the core network 102.

In case of mobile communication standard such as LTE, the radio access network 101, i.e. the E-UTRAN 101 in case of LTE, may be seen to consist of the base station 103, i.e. the eNBs 103 in case of LTE, providing the E-UTRA user plane (PDCP/RLC/MAC) and control plane (RRC) protocol terminations towards the UE 105.

Each base station 103 of the communication system 100 may control communications within its geographic coverage area, namely its mobile radio cell 104 that is ideally represented by a hexagonal shape. When the mobile terminal 105 is located within a mobile radio cell 104 and is camping on the mobile radio cell 104 (in other words is registered with a Tracking Area (TA) assigned to the mobile radio cell 104) it communicates with the base station 103 controlling that mobile radio cell 104. When a call is initiated by the user of the mobile terminal 105 (mobile originated call) or a call is addressed to the mobile terminal 105 (mobile terminated call), radio channels are set up between the mobile terminal 105 and the base station 103 controlling the mobile radio cell 104 in which the mobile station is located. If the mobile terminal 105 moves away from the original mobile radio cell 104 in which a call was set up and the signal strength of the radio channels established in the original mobile radio cell 104 weakens, the communication system may initiate a transfer of the call to radio channels of another mobile radio cell 104 into which the mobile terminal 105 moves.

Using its connection to the E-UTRAN 101 and the core network 102, the mobile terminal 105 can communicate with other devices located in other networks, e.g. a server in the Internet, for example for downloading data using a TCP (Transport Control Protocol) connection according to FTP (File Transport Protocol) or for exchanging data (e.g. speech or video data) with another mobile terminal.

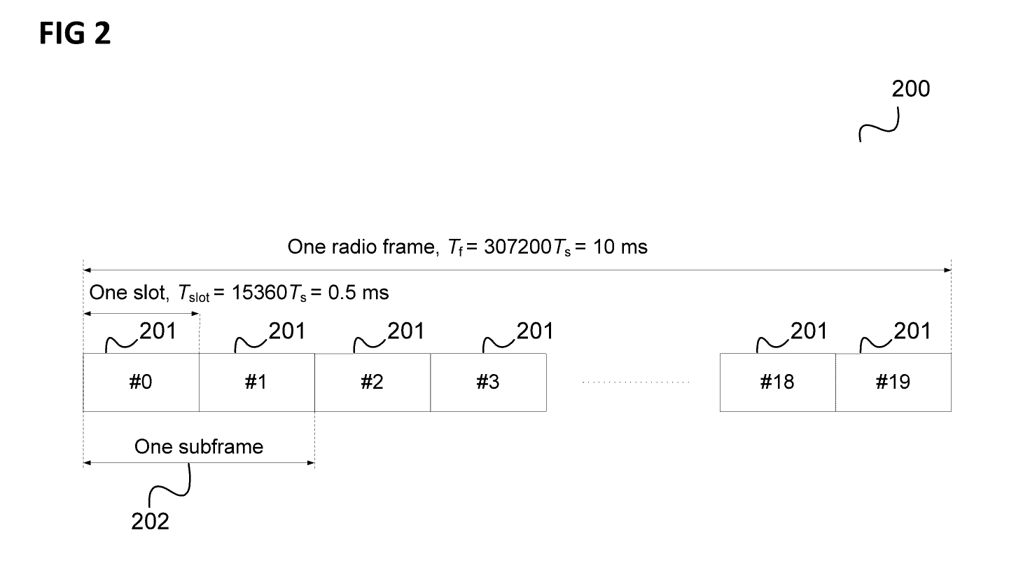

Data transmission between the mobile terminal 105 and the corresponding base station 103 (i.e. the base station operating the radio cell in which the mobile terminal 105 is located) is carried out according to a (radio) frame structure. An example of a frame structure is shown in FIG. 2.

FIG. 2 shows a frame 200 of an exemplary frame structure.

The frame 200 may be used for both full-duplex and half-duplex FDD. The frame 200 is 10 ms long and consists of 20 slots 201 of length 0.5 ms, numbered from 0 to 19. A subframe 202 is defined as two consecutive slots 201. In each 10 ms interval ten subframes 202 are available for downlink transmissions or uplink transmissions. It should however be noted that according to other radio access technologies like e.g. WIFI, a frame may have a different number of subframes than ten and a subframe may include more than two slots. Uplink and downlink transmissions are separated in the frequency domain. Depending on the slot format a subframe 202 may include 12 or 14 OFDM (orthogonal frequency division multiple access) symbols in DL (downlink) and 12 or 14 SC-FDMA symbols in UL (uplink), respectively.

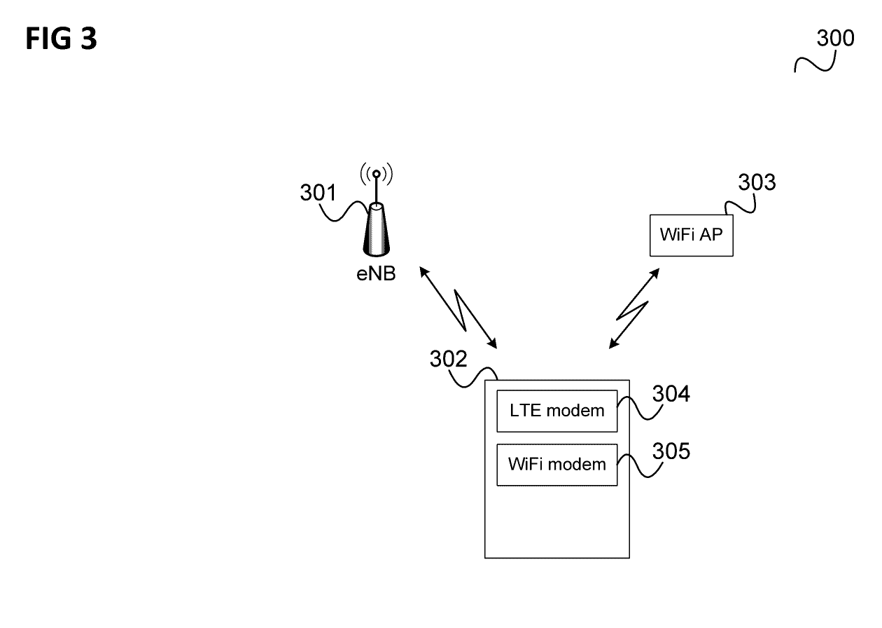

For being able to communicate with the E-UTRAN 101 the mobile terminal 105 includes an LTE modem 111. The mobile terminal 105 may support other radio access technologies than, in this example, LTE. For example, the mobile terminal 105 further includes a WiFi modem 112 which allows the mobile terminal 105 to establish a connection to a WiFi access point. This is illustrated in FIG. 3.

FIG. 3 shows a communication arrangement 300.

The communication arrangement 300 includes an eNodeB 301, for example corresponding to one of the base stations 103, a mobile terminal 302, for example corresponding to the mobile terminal 105 and a WiFi access point (AP) 303 of a wireless local area network (WLAN). The mobile terminal 302 includes an LTE modem 304 and a WiFi modem 305. This allows the mobile terminal 302 to exchange signals with the eNodeB 301 as well as with the WiFi access point 303.

It should be noted that a relevant use case for usage of unlicensed bands is LTE Small Cell usage. Accordingly, the term eNodeB is in particular meant to include an LTE Small Cell eNodeB.

The ever-increasing mobile broadband traffic load leads to a pressing need for additional spectral resources of cellular systems such as the communication system 100, which are deployed in the spectrum mainly from 700 MHz to 2.6 GHz. On the other hand, the amount of unlicensed spectrum assigned or currently planned to be assigned is comparable to or even more than the amount of licensed spectrum such as used by WiFi. Therefore, to further expand LTE capacity to meet the traffic demands, a natural way is to integrate unlicensed carrier into the overall LTE system by adapting LTE air interface to operate in the unlicensed spectrum.

This may be done by Licensed Shared Access (LSA) and Spectrum Access System (SAS). The target bands for LSA are in 2.3-2.4 GHz (or a subset) and for SAS 3.55-3.7 GHz (or a sub-set). There may be further frequency bands to which LSA/SAS is applied, e.g. in the region of 3.5 GHz in Europe.

Licensed Shared Access (LSA) Technology is currently defined by CEPT (European Regulation Authorities) and ETSI Standardization (ETSI RRS).

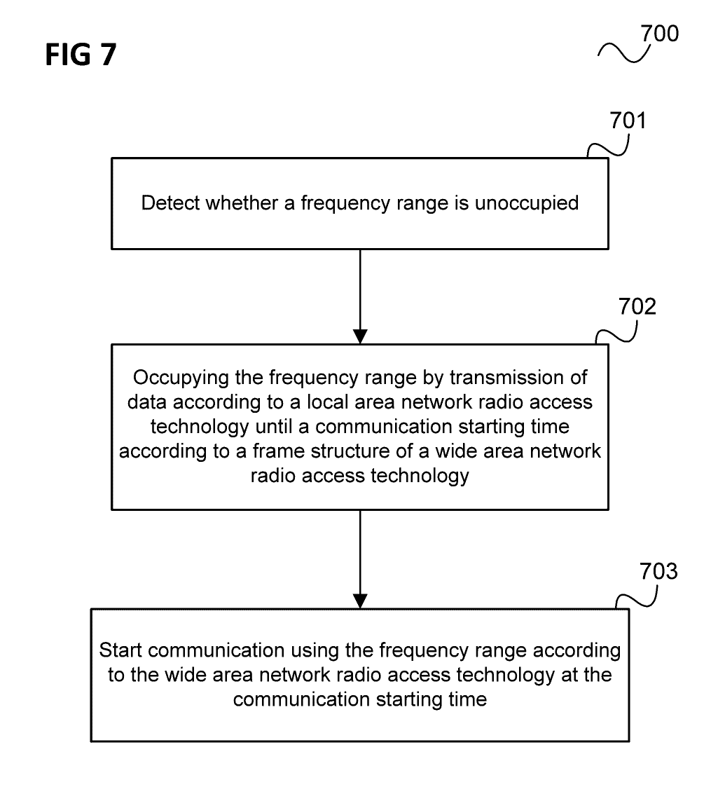

FIG. 4 illustrates LSA for spectrum management.

LSA allows the usage of occupied (but underused) bands by MNOs (Mobile Network Operators) on a Licensed Shared basis. I.e., incumbents 401 guarantee the availability of the spectrum for a given period of time, for a given geographic area as illustrated by radio cells 402 e.g. corresponding to radio cells 104 and a given spectrum band to a given MNO, typically for deploying LTE in this band, via an LSA repository 403. An LSA controller 404 accesses the LSA repository 403 and the MNO controls, as represented by an OA&M (Operation, Administration & Maintenance) the communication network (e.g. base stations 406 operating radio cells 402) accordingly. Thus, the MNO receives QoS guarantees and pays in return for the spectrum. In Europe, the current focus is on LTE TDD Band 40, i.e., 2.3-2.4 GHz. It is assumed that the band will be made available under the LSA regime within 2-5 years.

In the US, a similar scheme was introduced by the FCC (Federal Communications Commission) called Spectrum Access System (SAS), targeting the usage of (licensed) spectrum sharing in 3.55-3.65 GHz.

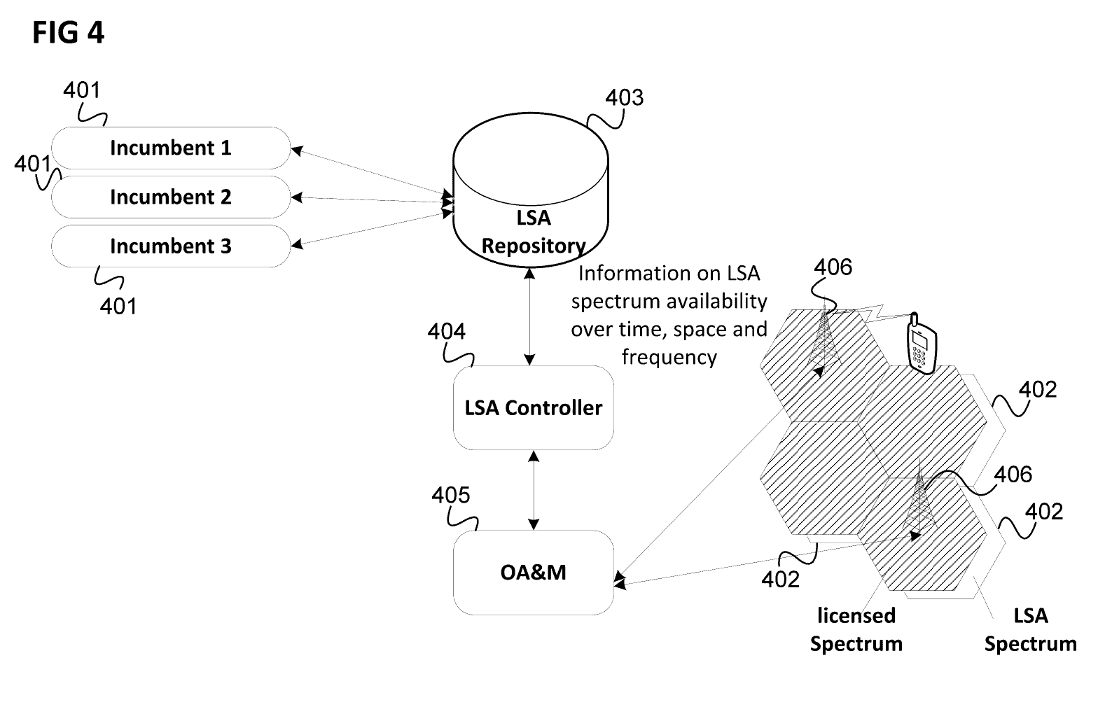

FIG. 5 illustrates SAS for spectrum management.

The FCC's Spectrum Access System (SAS) coordinates the spectrum use between the incumbents, PAL (Priority Access License) Users and GM (General Authorized Access) Users. The SAS providers (or SAS entity) 501 obtain information about registered or licensed commercial users in the band from an FCC database 502 and information about federal incumbent users of the band from ESC (Environmental Sensing Capability) 503. The SAS providers 501 may also interact directly or indirectly through a proxy 504—such as a network manager—with CBSDs (Citizens Broadband Radio Service Devices) 505 operating in the band to ensure that Citizens Broadband Radio Service users 506 operate in a manner consistent with their authorizations and promote efficient use of the spectrum resource. SAS-to-SAS synchronization ensures coordination occurs even between CBSDs that use different SAS providers, i.e. multiple SASs are supposed to be synchronized with each other.

The SAS is central to the respective band, and no tier 2 or tier 3 device can operate unless it is in constant communication with the SAS provider and receives information of when and where to use the 3.5 GHz channels. The SAS provider has to be approved by the FCC before it can be deployed. Since the SAS is the central coordinator for the spectrum, it needs to have substantial information about the network and devices. In fact, FCC mandates most of this information to be contained in the SAS.

In the following, examples are described with reference to LSA. However, typically all LSA mechanisms (including in particular the examples described in the following) may also be applied to SAS. Thus, the examples described in the following may be applied to both LSA and SAS. Actually, in LSA the switch to the unlicensed band requires that the carrier frequency is switched to a WiFi unlicensed band such as 2.4 GHz or 5 GHz. In SAS, the same is true—additionally, however, SAS allows to operate WiFi within the SAS band as a tier-3 user (“General Authorized Access (GM)” User). Such a tier-3 user does not exist in LSA. LSA only allows licensed shared users which correspond to tier-2 users in SAS (“Priority Access License (PAL)” User—when the incumbent comes in and the PAL band needs to be vacated, the switch to WiFi may still occur within the SAS spectrum if a portion of GM spectrum is not covered by the incumbent).

Spectrum handover decisions may for example be taken and executed in an SAS entity 501 or in the LSA controller 404.

The LTE Licensed-Assisted Access (LAA) Carrier Aggregation deployment means aggregating a primary cell, using licensed spectrum (e.g. licensed by an LTE mobile network operator), to deliver critical information and guaranteed Quality of Service, and a co-located secondary cell, using unlicensed spectrum (e.g. WiFi spectrum), to opportunistically boost throughput. Accordingly, in the future, LTE-LAA and WiFi can be expected to have both access to, for example, the ISM 5 GHz spectrum, which may lead to interference between these two radio access technologies.

In the following, a communication device (e.g. a mobile terminal or a base station) which provides a mechanism that allows LTE-LAA to operate while ensuring that WiFi does not interfere with the LTE-LAA communication. A coexistence of LTE-LAA and WiFi may for example be used as a way for the offloading of Licensed Shared Access (LSA) Networks.

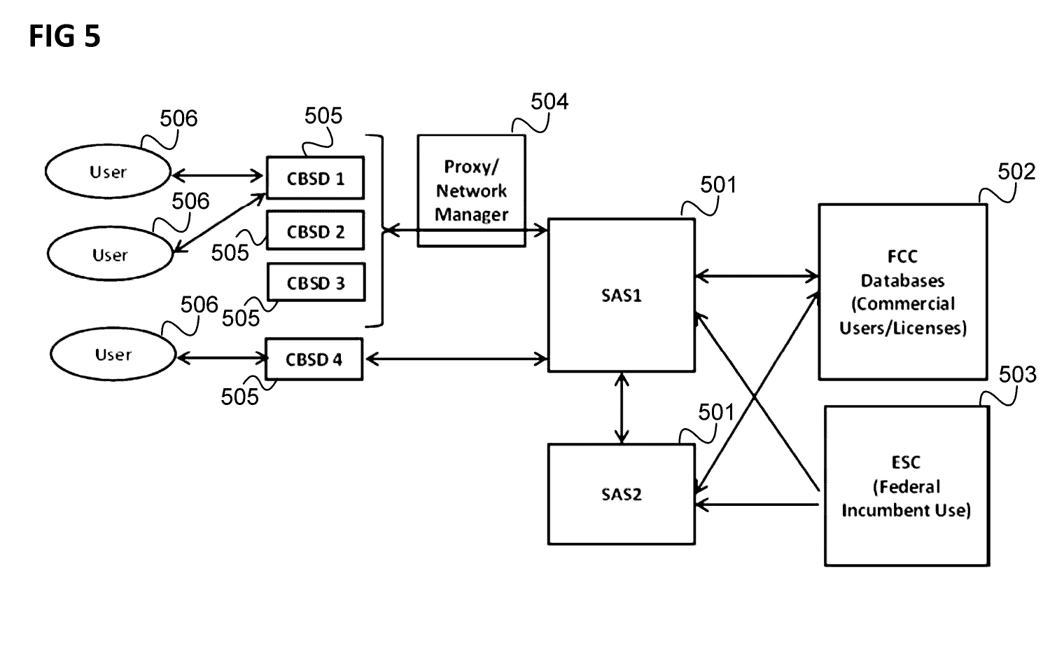

FIG. 6 shows a communication device 600.

The communication device 600 includes a transceiver 601 configured for communication according to a wide area network radio access technology and configured for communication according to a local area network radio access technology.

Further, the communication device 600 includes a detector 602 configured to detect whether a frequency range is unoccupied.

The communication device 600 further includes a controller 603 configured to control the transceiver to, if the frequency range is unoccupied, transmit data according to the local area network radio access technology to occupy the frequency range until a communication starting time according to a frame structure of the wide area network radio access technology and to control the transceiver to start communication using the frequency range according to the wide area network radio access technology at the communication starting time.

In other words, a communication device uses a data transmission according to a local area network radio access technology to reserve a frequency range and then uses the reserved frequency range for communication according to the wide area network radio access technology. It should be noted that the term communication is used to include a transmission of data as well as a reception of data, in other words a data exchange. For example, if the communication device is a base station, it may include downlink transmission of data to a communication terminal as well as uplink reception of data from the communication terminal.

For example, if the local area network radio access technology is WiFi, the transmission of data according to the local area network radio access technology allows legacy neighboring WiFi devices to detect the transmission and remain silent. This finallys lead to a protection of the communication according to the wide area network radio access technology (e.g. an LTE-LAA communication) part which is not detectable by legacy WiFi equipment.

For ensuring a high level of efficiency and reliability, rather than transmitting a blocking signal, the communication device may use the time between the detection that the frequency range is unoccupied and the communication starting time (e.g. LTE subframe start time), in other words the waiting time, to transmit a signal according to the local area network radio access technology (e.g. a WiFi signal) which prevents other WiFi nodes (i.e. WiFi devices) from transmitting and also obtain certain capacity. The device may include useful data into this signal to obtain a certain additional capacity. This may be seen as a kind of time domain aggregation of WiFi communication and LTE communication. For example, the transmission of data according to the local area network radio access technology includes a transmission of a first part of a continuous data stream which is seamlessly continued by the communication using the frequency range according to the wide area network radio access technology.

The communication is for example a communication to a second communication device, e.g. a communication terminal (e.g. a subscriber terminal such as a UE). The communication device may use the transmission of data according to the local area network radio access technology to transmit useful data to the communication terminal and then continue transmitting useful data to the communication terminal by means of the communication using the frequency range according to the wide area network radio access technology.

The communication according to the wide area network radio access technology and the transmission according to the local area network radio access technology may be operated using two corresponding transceiver systems in a single communication device with a single control entity (scheduler) for both systems. There may be a short silence period between the transmission according to the wide area network radio access technology (e.g. WiFi transmission frames) and the communication according to the local area network radio access technology (e.g. LTE-LAA/LTE-U frames).

For example, the wide area network radio access technology (RAT) is a Wireless Wide Area Network (WWAN) RAT and the local area network radio access technology is a Wireless Local Area Network (WLAN) RAT. Thus, the communication device for example uses WLAN radio access technology (e.g. WiFi) to reserve a frequency range and then uses the reserved frequency range for WWAN communication, e.g. LTE-LAA communication in a WLAN frequency band, such as the 5 GHz band used according to IEEE 802.11a.

A Wireless Wide Area Network (WWAN) may be understood as a wide radio network, in other words a radio network with a large coverage, e.g. a cellular radio network for mobile phones. In contrast to a Wireless Local Area Network (WLAN) the WWAN covers a larger (outdoor) communication distance. Examples for WWANs include LTE, WiMAX, GSM and UMTS radio communication networks.

A Wireless Local Area Network (WLAN) may be understood to refer to a local radio network, e.g. according to a standard of the IEEE 802.11 family. A WLAN according to a standard of the IEEE 802.11 family is also referred to as WiFi radio network.

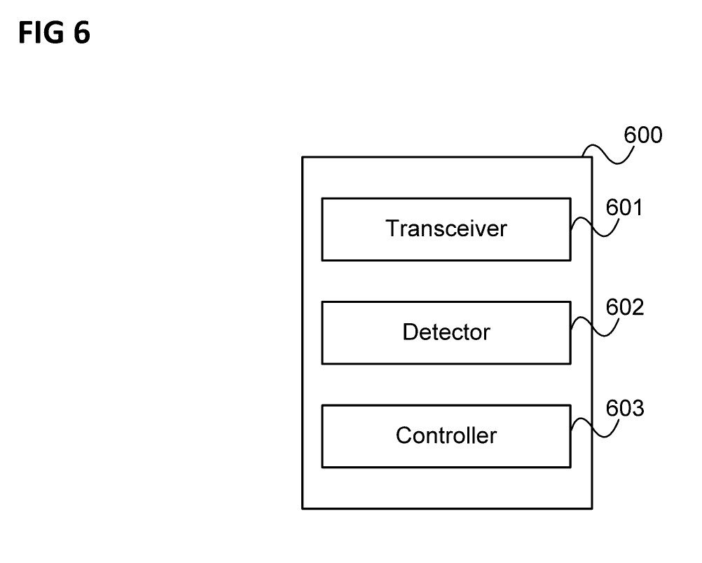

The communication device for example carries out a method as illustrated in FIG. 7.

FIG. 7 shows a flow diagram 700 illustrating a method for communicating using a frequency range, for example carried out by a communication device.

In 701, the communication device detects whether a frequency range is unoccupied.

In 702, the communication device transmits data according to a local area network radio access technology to occupy the frequency range until a communication starting time according to a frame structure of a wide area network radio access technology if the frequency range is unoccupied.

In 703, the communication device starts communication using the frequency range according to the wide area network radio access technology at the communication starting time.

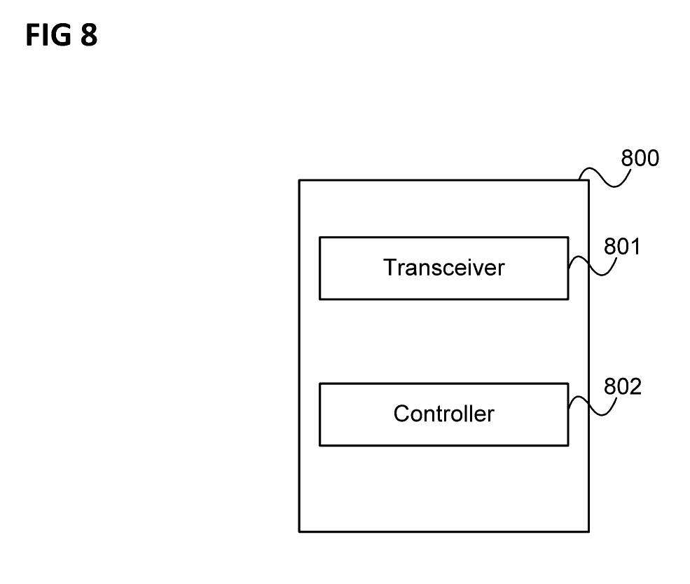

Instead of an occupation of the frequency range by transmitting data according to the local area network radio access technology, the communication device may reserve the frequency range using a reservation message. This is illustrated in FIG. 8.

FIG. 8 shows a communication device 800.

The communication device 800 includes a communication device including a transceiver 801 configured for communication according to a first radio access technology (e.g. a wide area network radio access technology) and configured for communication according to a second radio access technology (e.g. a local area network radio access technology).

The communication device 800 further includes a controller 802 configured to control the transceiver 801 to send a reservation message in a frequency range according to the second radio access technology for reserving a frequency range in the radio communication band for communication by the communication device for a predetermined time interval and to transmit data to a second communication device and to receive data from the second communication device during the time interval according to the first radio access technology.

In other words, the communication device reserves the frequency range for transmission and reception (e.g. uplink and downlink transmission) according to a first radio access technology (e.g. LTE) using a reservation message according to the second radio access technology (such as a CTS message or an RTS message according to WiFi).

The approach described with reference to FIG. 8 can be seen as a joint management of, for example, WiFi and LTE-LAA access. For example, the communication device 800 (e.g. a base station or a communication terminal) uses an RTS/CTS (request to send/clear to send) mechanism according to WiFi in order to ensure that WiFi does not interfere with LTE-LAA transmissions. For example, a communication terminal (e.g. a subscriber terminal such as a UE) issues a dummy transmission request according to WiFi in order to vacate the WiFi band (i.e. a sufficient frequency range) for LTE-LAA and a base station replies with a clear to send message.

The communication device may first detect whether the frequency range is unoccupied (i.e. vacant). For example, a base station (e.g. an eNodeB) detects whether the frequency range (e.g. frequency channel) is vacant, e.g. according to WLAN CCA (Clear Channel Assessment) and transmits a dummy CTS if the channel is vacant.

Alternatively, the communication terminal (e.g. the UE) detects whether the frequency range is unoccupied (e.g. performs CCA) and transmits an RTS to then get a CTS from the base station. This creates a high level of visibility to other communication systems (e.g. other WLAN communication devices) and thus allows a high performance of the communication system (of which the communication is part). A base station can delegate the sensing in one or more WiFi bands to a UE by for example assigning the UE to start sensing a WiFi band or a specific WiFi channel. The base station accordingly knows when to wait for an RTS from the UE. An indication to the downlink control channel of LTE may be added (e.g. with a corresponding modification of the LTE standard) for such an assignment. Alternatively, the UE may constantly listen to the WiFi band at the cost of the UE's battery power (but without modification of the LTE standard).

The approaches described in reference to FIGS. 6 to 8 allow a mutual protection of LTE-LAA and WiFi and thus avoiding interference of WiFi onto LTE-LAA.

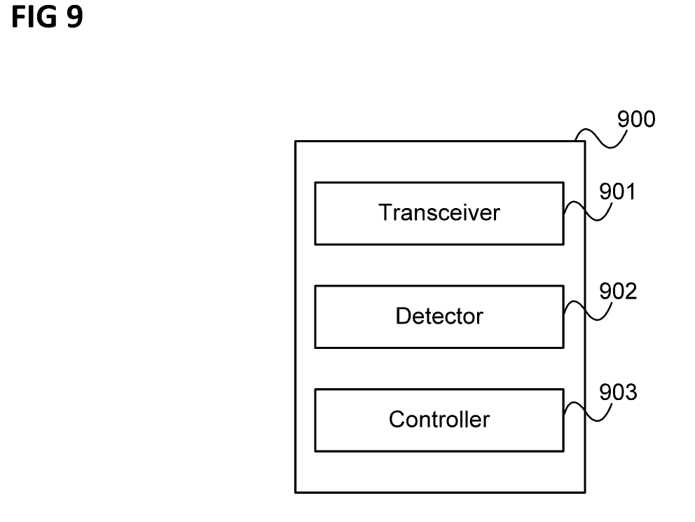

The communication device may for example use the joint operation of LTE and WiFi as a way for the offloading of an LSA network. More generally, the approaches described with reference to FIGS. 6 to 8 may for example be used in an approach as described in the following with reference to FIG. 9.

FIG. 9 shows a communication device 900.

The communication device 900 comprises a first transceiver 901 configured to communicate using a first frequency range outside of the unlicensed industrial, scientific, and medical (ISM) band and to communicate using a second frequency range in the ISM band.

The communication device 900 further comprises a detector 902 configured to detect that a second transceiver of a second communication device has initiated or is about to initiate usage of the first frequency range and that the second transceiver has a higher priority for usage of the first frequency range than the first transceiver 901.

Further, the communication device 900 comprises a controller 903 configured to control the first transceiver 901 to perform a communication using the second frequency range in the ISM band in response to the detection that the second transceiver has initiated or is about to initiate usage of the first frequency range.

In other words, a communication device communicates using a shared frequency band and performs an offloading to ISM (Industrial, Scientific and Medical) band in case a user with higher priority (e.g. an incumbent user) becomes present (e.g. reclaims the frequency range used by the communication device 900).

The components of the communication devices 600, 800, 900 (e.g. the transceivers, detectors and controllers) may for example be implemented by one or more circuits. A “circuit” may be understood as any kind of a logic implementing entity, which may be special purpose circuitry or a processor executing software stored in a memory, firmware, or any combination thereof. Thus a “circuit” may be a hard-wired logic circuit or a programmable logic circuit such as a programmable processor, e.g. a microprocessor. A “circuit” may also be a processor executing software, e.g. any kind of computer program. Any other kind of implementation of the respective functions which will be described in more detail below may also be understood as a “circuit”.

It should be noted that methods for performing a communication according to the approaches described with reference to FIGS. 8 and 9 may also be provided.

The following examples pertain to further embodiments.

Example 1 is a communication device as illustrated in FIG. 6.

In Example 2, the subject matter of Example 1 may optionally include the communication starting time being a frame or subframe starting time according to a frame structure of the wide area network radio access technology.

In Example 3, the subject matter of any one of Examples 1-2 may optionally include the wide area network radio access technology being LTE.

In Example 4, the subject matter of Example 3 may optionally include the wide area network radio access technology being LTE for unlicensed band usage.

In Example 5, the subject matter of any one of Examples 3-4 may optionally include the controller being configured to control the transceiver to start communication using the frequency range according to LTE-Unlicensed (LTE-U) at the communication starting time.

In Example 6, the subject matter of any one of Examples 3-5 may optionally include the communication starting time being an LTE subframe.

In Example 7, the subject matter of any one of Examples 1-6 may optionally include the local area network radio access technology being WiFi.

In Example 8, the subject matter of any one of Examples 1-7 may optionally include the data transmitted with the transmission of data according to the local area network radio access technology including an indication of a length of usage of the frequency range by the communication device.

In Example 9, the subject matter of Example 8 may optionally include the length of usage of the frequency range by the communication device including the duration of the communication using the frequency range according to the wide area network radio access technology.

In Example 10, the subject matter of any one of Examples 1-9 may optionally include the transmission of data according to the local area network radio access technology being a transmission of data to a second communication device.

In Example 11, the subject matter of Example 10 may optionally include the communication using the frequency range according to the wide area network radio access technology being a communication with the second communication device.

In Example 12, the subject matter of any one of Examples 10-11 may optionally include the data transmitted with the transmission of data according to the local area network radio access technology including useful data to be transmitted to the second communication device.

In Example 13, the subject matter of Example 12 may optionally include the transmission of data according to the local area network radio access technology including a transmission of a first part of a data stream and the communication using the frequency range according to the wide area network radio access technology including a transmission of a second part of the data stream.

In Example 14, the subject matter of any one of Examples 10-13 may optionally include the communication device being a base station and the second communication device being a subscriber terminal or the communication device being a subscriber terminal and the second communication device being a base station.

In Example 15, the subject matter of any one of Examples 1-14 may optionally include the frequency range corresponding to a frequency channel of the local area network radio access technology.

In Example 16, the subject matter of any one of Examples 1-15 may optionally include the transceiver comprising a first modem for communication according to the wide area network radio access technology and comprising a second modem for communication according to a local area network radio access technology.

In Example 17, the subject matter of any one of Examples 1-16 may optionally include the communication device being a base station or a communication terminal.

Example 18 is a method for communicating using a frequency range as illustrated in FIG. 7.

In Example 19, the subject matter of Example 18 may optionally include the communication starting time being a frame or subframe starting time according to a frame structure of the wide area network radio access technology.

In Example 20, the subject matter of Example 18 may optionally include the wide area network radio access technology being LTE.

In Example 21, the subject matter of Example 20 may optionally include the wide area network radio access technology being LTE for unlicensed band usage.

In Example 22, the subject matter of any one of Examples 20-21, may optionally include starting communication using the frequency range according to LTE-U at the communication starting time.

In Example 23, the subject matter of any one of Examples 20-22 may optionally include the communication starting time being an LTE subframe.

In Example 24, the subject matter of any one of Examples 18-23 may optionally include the local area network radio access technology being wireless local area network radio access technology.

In Example 25, the subject matter of any one of Examples 18-24 may optionally include the data transmitted with the transmission of data according to the local area network radio access technology including an indication of a length of usage of the frequency range.

In Example 26, the subject matter of Examples 25 may optionally include the length of usage of the frequency range including the duration of the communication using the frequency range according to the wide area network radio access technology.

In Example 27, the subject matter of any one of Examples 18-26 may be performed by a communication device and may optionally include the transmission of data according to the local area network radio access technology being a transmission of data to a second communication device.

In Example 28, the subject matter of Example 27 may optionally include the communication using the frequency range according to the wide area network radio access technology being a communication with the second communication device.

In Example 29, the subject matter of Example 27 may optionally include the data transmitted with the transmission of data according to the local area network radio access technology including useful data to be transmitted to the second communication device.

In Example 30, the subject matter of Example 29 may optionally include the transmission of data according to the local area network radio access technology including a transmission of a first part of a data stream and the communication using the frequency range according to the wide area network radio access technology including a transmission of a second part of the data stream.

In Example 31, the subject matter of Example 27 may optionally include the communication device being a base station and the second communication device being a subscriber terminal or the communication device being a subscriber terminal and the second communication device being a base station.

In Example 32, the subject matter of any one of Examples 18-31 may optionally include the frequency range corresponding to a frequency channel of the local area network radio access technology.

In Example 33, the subject matter of any one of Examples 18-32 may optionally include performing the communication according to the wide area network radio access technology by means of a first modem and performing the transmission of data according to a local area network radio access technology by means of a second modem.

In Example 34, the subject matter of any one of Examples 18-33 may be performed by a base station or a communication terminal.

Example 35 is a communication device as illustrated in FIG. 8.

In Example 36, the subject matter of Example 35 may optionally include the reservation message being a clear to send message.

In Example 37, the subject matter of Example 35 may optionally include the reservation message being a dummy clear to send message.

In Example 38, the subject matter of any one of Examples 35-37 may optionally include the controller being configured control the transceiver to send the reservation message in response to the reception of a request to send message from the second communication device.

Example 39 is a communication device as illustrated in FIG. 9.

In Example 40, the subject matter of Example 39 may optionally include the further communication device being an incumbent user of the frequency range.

In Example 41, the subject matter of any one of Examples 39-40 may optionally include the controller being configured to control the first transceiver to avoid performing the communication using the first frequency range in response to the detection that the second transceiver has initiated or is about to initiate usage of the first frequency range.

In Example 42, the subject matter of any one of Examples 39 to 41 can optionally include the first transceiver being an LTE transceiver.

It should be noted that one or more of the features of any of the examples above may be combined with any one of the other examples.

In the following, embodiments are described in more detail.

For the following examples, a communication system (e.g. as described with reference to FIG. 1) is assumed for which

i) a dedicated licensed band,

ii) a shared band

(like LSA band in Europe 2.3-2.4 GHz, SAS in US in 3.55-3.70 GHz, etc.) and

iii) an unlicensed band (such as ISM)

are available for communication.

Mechanisms for protecting LTE-LAA from WiFi as described in the following are however applicable in any type of environment with unlicensed bands, e.g. in an environment where no shared bands, e.g. no LSA bands are available, e.g. in a scenario where an LTE communication system offloads traffic from a licensed band to an unlicensed band (e.g. ISM).

LSA provides a mobile network operator (MNO) of a communication network with spectral resources (in an LSA band) in addition to their licensed resources. However, if an incumbent user requires the spectral resources back, the communication network has to offload the communication terminals using the LSA spectral resources from the LSA band to other spectral resources (i.e. another frequency range). Unlicensed spectrum such as the ISM band is a possible candidate for such other spectral resources.

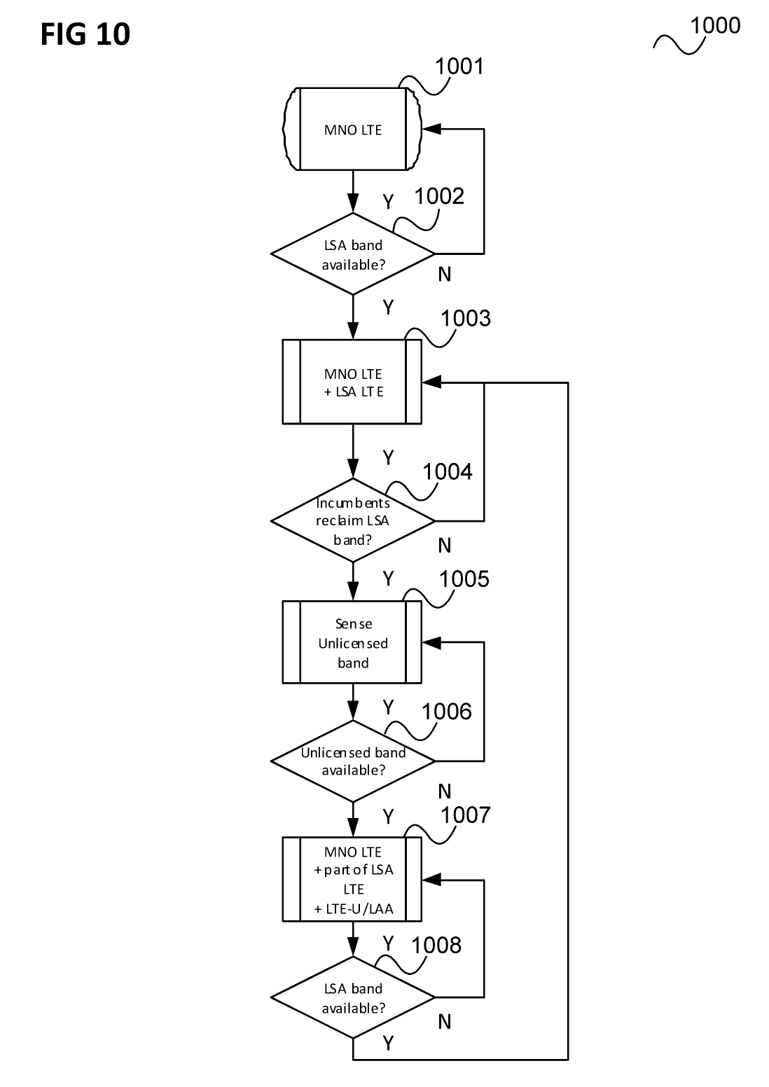

FIG. 10 shows an LSA offloading procedure (for example performed by the communication device 900 of FIG. 9).

In 1001, a radio communication network, e.g. according to LTE as illustrated in FIG. 1, serves one or more UEs using a frequency band licensed by the mobile network operator (also referred to as MNO band in the following).

In 1002, a component of the radio communication network, e.g. a base station, senses an LSA band (i.e. detects whether the LSA band, e.g. a certain frequency range within the LSA band, is occupied or is free) or receives spectrum information from an LSA controller to obtain the geolocation area, available time and transmitting power constraints of the LSA band. If an LSA band (e.g. a certain frequency range within the LSA band) is available for usage by the radio communication network to serve the UEs, the procedure continues with 1003. Otherwise, the radio communication network continues to serve the UEs with the MNO band (802 is for example performed periodically).

In 1003, the radio communication network serves the UEs using the MNO band and the LSA band (in other words runs LTE in the MNO band and the LSA band).

In 1004, if a part of the LSA band (e.g. a frequency range) becomes unavailable for the radio communication network (e.g. if an incumbent user reclaims a part of the LSA band), the UEs have to depart from the reclaimed LSA band part (i.e. can no longer be served using the reclaimed LSA band part). Therefore, in 1007, the radio communication network tries to offload those UEs using the reclaimed LSA band part from the missing LSA band to the unlicensed band. During the band moving time (i.e. the moving of the UEs to the unlicensed band), the radio communication network may continue to run LTE in the MNO band and the LSA band.

For example, an incumbent user may allow an MNO to offload UEs within a certain band moving time starting from a notification of the reclamation. For example, after the radio communication network receives an LSA band reclaiming notification from an LSA controller, the base stations affected by the LSA band reclamation start to sense the unlicensed band in 1005, and, if unlicensed band is available, start to serve the UEs using the MNO band, the unclaimed part of the LSA band (according to LTE) and the unlicensed band (according to LTE-U/LAA).

The switch to the unlicensed band may occur for LSA. In SAS, it may be the same or alternatively the switch may occur to SAS GM spectrum where the operation of WiFi is also possible (in case that some GM spectrum is not used by the incumbent and remains available for tier-3 usage). This applies to all examples.

If, in 1008, the radio communication networks detects that the reclaimed LSA band part is again available, it may return to 1003 of the procedure.

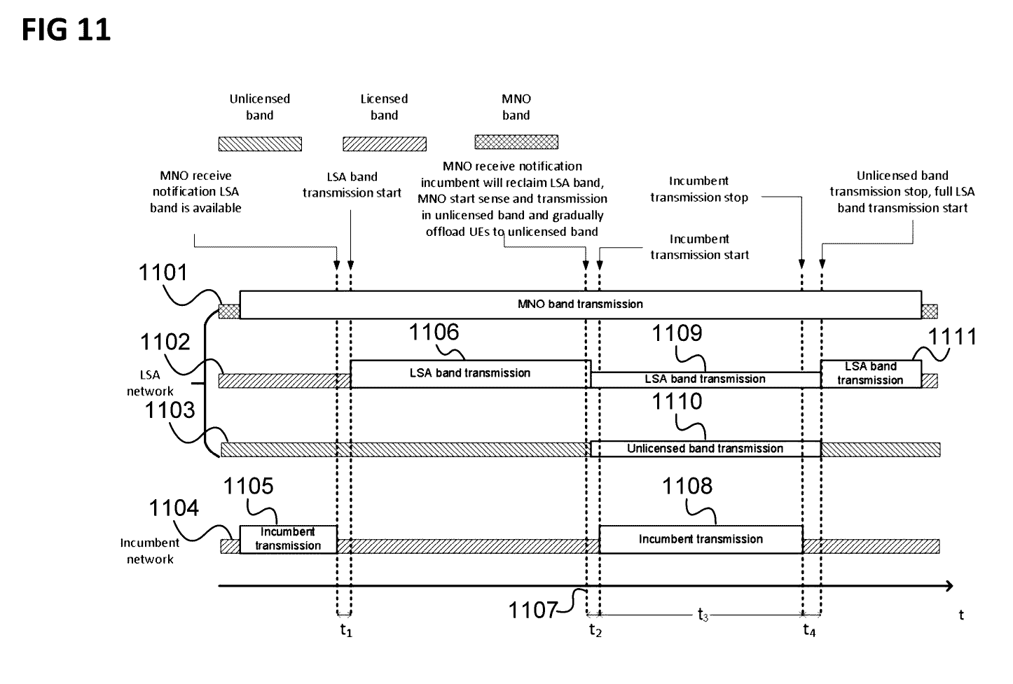

FIG. 11 illustrates a transmission process of the LSA offloading procedure of FIG. 10.

In FIG. 11, time flows from left to right and shows a representation of the MNO band 1101, a first representation of the LSA band 1102 for illustrating usage of the LSA band by the radio communication network, a representation of the unlicensed band 1103 and a second representation of the LSA band 1102 for illustrating usage of the LSA band by an incumbent user, an incumbent network in this example.

In this example, it is assumed that a first incumbent transmission 1105 on LSA band finishes and the radio communication network is notified (e.g. by an LSA controller) that the LSA band is available. After a delay t₁, the radio communication network (e.g. certain one or more base stations operating a region where the LSA band is available) starts a first LSA band communication 1106 in the full LSA band (e.g. start serving one or more UEs using the LSA band).

At some point in time 1107, the incumbent network informs the radio communication network that it reclaims a part of the LSA band for a second incumbent transmission 1108 which is started after a time t₂, e.g. a band moving time granted to the mobile network operator. During the time t₂, the radio communication network reduces the LSA band usage to the unclaimed part (illustrated by a second LSA band communication 1109) and offloads the remaining traffic to an unlicensed band communication 1110. When the second incumbent transmission 1108 is finished (after a time t₃), the radio communication network may return to the full LSA band usage (illustrated by a third LSA band communication 1111) and may stop the unlicensed band communication 1110 after a time t₄.

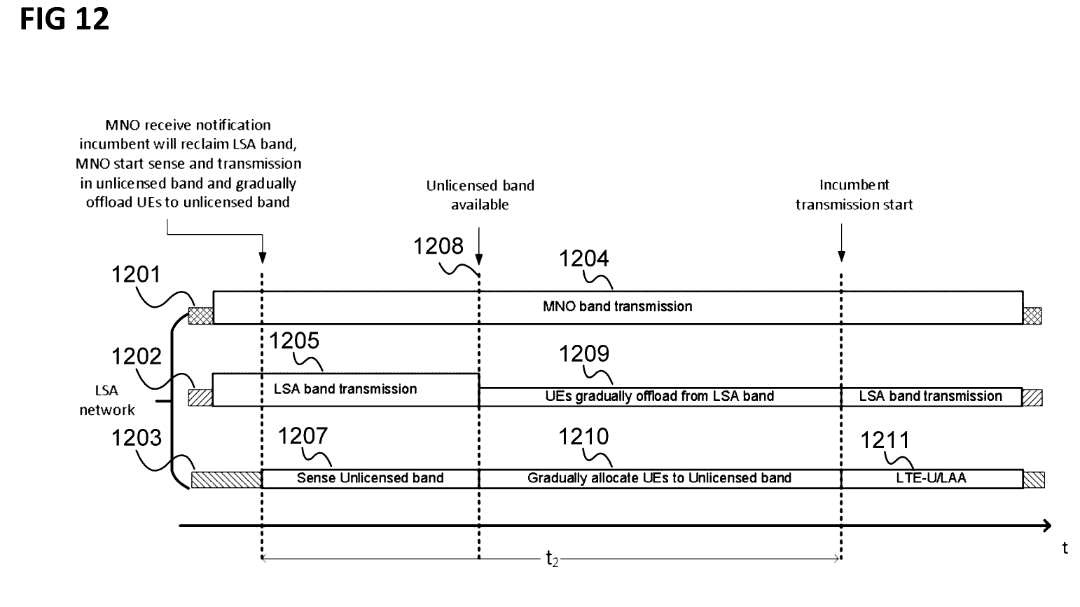

FIG. 12 shows the channel moving process from LSA band to unlicensed band during the band moving time t₂ in more detail.

Similarly to FIG. 11, time flows from left to right in FIG. 12 and a representation of the MNO band 1201, a representation of the LSA band 1202 and a representation of the unlicensed band 1203 are shown.

As described with reference to FIG. 11, the radio communication network performs an MNO band communication 1204 and a first LSA band communication 1205 and then receives, at a first time 1206, a notification from the incumbent network that it reclaims a part of the LSA band. This starts the band moving time t₂.

During the band moving time, the radio communication network performs a sensing of the unlicensed band 1207 and when the unlicensed band is determined to be available at a second time 1208 performs and offloading of traffic from the LSA band to the unlicensed band 1209, 1210 (i.e. reallocation of UEs from the LSA band to the unlicensed band) before the start of a second incumbent communication 1211.

In the following, examples for the sensing and access process to the unlicensed band are described, wherein it is assumed that the radio communication network intends to use a WiFi band (e.g. the ISM 5 GHz WiFi band) as the unlicensed band for offloading of traffic. Thus, the following approaches address the coexistence of an unlicensed network, specifically a WiFi network, with LTE unlicensed users. They can be seen as examples of the approaches described with reference to FIGS. 6 to 8.

In the following examples, the transmission time for LTE-U (LTE usage of the unlicensed band) is smaller than or equal to the maximum WiFi transmission time as defined according to 802.11 spec. (APPDUMaxTime=5.484 ms, for very high throughput (VHT) or 10 ms for high throughput greenfield (HT-GF)). The starting time of the LTE-U communication is aligned with the start of an LTE subframe. This typically implies a waiting time between sensing that a channel in the unlicensed is free (unoccupied) and the start of the LTE-U communication.

According to the parameters in the WiFi and the LTE standard, different transmission schemes are listed as:

| | APPDUMaxTime = 5.484 ms | APPDUMaxTime = 10 ms |
|---|---|---|
| TDD-LTE | SDL/UL depending on the | SDL/UL depending on the |
| | UL/DL configuration | UL/DL configuration |
| FDD-LTE | UL and DL | UL and DL |

where SDL is supplementary downlink in LTE. If the maximum WiFi transmission time is smaller than 5.848 ms it is not sufficient to allow scheduling an uplink LTE subframe within the WiFi transmission time.

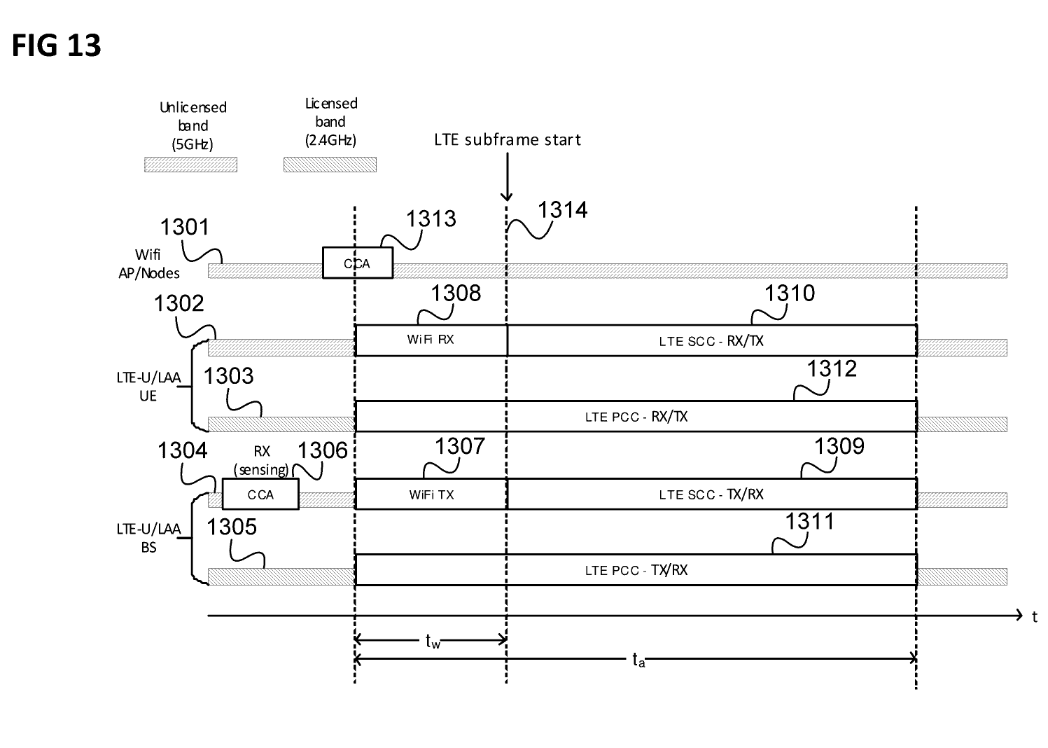

FIG. 13 illustrates a coexistence mechanism which is based on a clear channel assessment (CCA) and a following WiFi transmission by the LTE radio communication network (e.g. performed by a base station).

Similarly to FIG. 11, time flows from left to right in FIG. 13. FIG. 13 shows a first representation of the unlicensed band 1301 for illustrating usage of the unlicensed band by a WiFi access point (AP) and one or more WiFi nodes, a second representation of the unlicensed band 1302 for illustrating usage of the unlicensed band by a UE, a first representation of a licensed band 1303 for illustrating usage of the licensed band by the UE, a third representation of the unlicensed band 1304 for illustrating usage of the unlicensed band by the base station and a second representation of the licensed band 1305 (MNO band) for illustrating usage of the licensed band by the base station.

In the following examples, when a usage of the unlicensed band (WiFi band) is indicated, this refers to a channel in the unlicensed band, e.g. a 20 MHz frequency channel according to WLAN. For the SAS case, the slotting is however done per 10 MHz channels. It is thus possible to bundle two such channels to a 20 MHz channel or to apply a 10 MHz WiFi configuration instead of bundling.

The base station performs a sensing (CCA) 1306. If the channel is clear, as assumed in this example, the base station starts WiFi transmission 1307 (according to IEEE 802.11) to the UE which accordingly performs WiFi reception 1308.

The WiFi transmission 1307 can be seen to act as a blocking signal such that WiFi nodes are prevented from transmitting over the channel since when one of the WiFi nodes performs CCA 1313 it detects the channel as busy and does not transmit (i.e. backs off).

The base station performs the WiFi transmission for a time t_{w} until the start of the next LTE subframe 1314.

The time t_{w} can thus be up to

LTE subframe start time−time of CCA 1306

which may be nearly 1 ms. Accordingly, just transmitting a blocking signal would be a waste of radio resources. Instead, the base station may include useful data in the WiFi transmission 1307. This assumes that the LTE-LAA UE supports WiFi access to the base station which can be expected since most of current UEs are equipped with both LTE and WiFi modems. The base station may mask the WiFi transmission with an UE identifier.

At the LTE subframe start time, the base station stops the WiFi transmission 1307 and starts an LTE transmission/reception 1309 in the unlicensed band and the UE accordingly performs LTE reception/transmission 1310 in unlicensed band (to form an uplink or downlink LTE communication between the base station and the UE in the unlicensed band). In parallel, the base station may perform an LTE transmission/reception 1311 in the licensed band and the UE may accordingly perform LTE reception/transmission 1312 in the licensed band (to form an uplink or downlink LTE communication between the base station and the UE in the licensed band). The WiFi transmission 1307 may include an indication of the length of the WiFi transmission 1307 that includes the duration tₐ of the LTE transmission/reception in unlicensed band 1309 such that the WiFi devices consider the channel to be occupied until the end of the LTE transmission/reception in unlicensed band 1309.

The UE may switch from the WiFi reception 1308 to the unlicensed band LTE reception/transmission 1310 at low cost because the WiFi transmission 1307 and the unlicensed band LTE transmission/reception 1309 are performed in the same band.

It should be noted that in case the time t_{w} is shorter than the time necessary for a valid WiFi packet transmission then the base station may transmit a blocking signal instead of the WiFi transmission 1307.

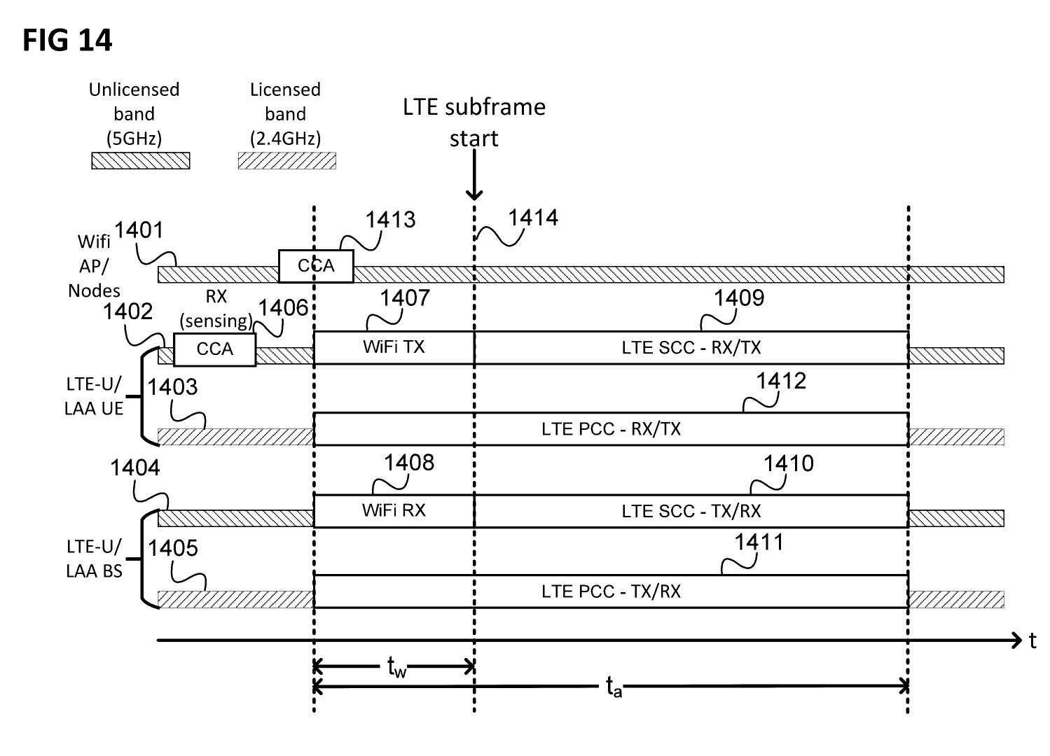

For uplink transmission, the base station may perform CCA 1306 and the UE performs the WiFi transmission 1307. Alternatively, the UE may perform both as illustrated in FIG. 14.

FIG. 14 illustrates a coexistence mechanism which is based on a clear channel assessment (CCA) and a following WiFi transmission performed by the UE.

Similarly to FIG. 11, time flows from left to right in FIG. 14. FIG. 14 shows a first representation of the unlicensed band 1401 for illustrating usage of the unlicensed band by a WiFi access point (AP) and one or more WiFi nodes, a second representation of the unlicensed band 1402 for illustrating usage of the unlicensed band by a UE, a first representation of a licensed band 1403 for illustrating usage of the licensed band by the UE, a third representation of the unlicensed band 1404 for illustrating usage of the unlicensed band by the base station and a second representation of the licensed band 1405 (MNO band) for illustrating usage of the licensed band by the base station.

The UE performs a sensing (CCA) 1406. If the channel is clear, as assumed in this example, the UE starts WiFi transmission 1407 (according to IEEE 802.11) to the base station which accordingly performs WiFi reception 1408.

The WiFi transmission 1407 can be seen to act as a blocking signal such that WiFi nodes are prevented from transmitting over the channel since when one of the WiFi nodes performs CCA 1413 it detects the channel as busy and does not transmit (i.e. backs off).

The UE performs the WiFi transmission for a time t_{w} until the start of the next LTE subframe 1414.

The time t_{w} can thus be up to LTE subframe start time−time of CCA 1406 which may be nearly 1 ms. Accordingly, just transmitting a blocking signal would be a waste of radio resources. Instead, the UE may include useful data in the WiFi transmission 1407. This assumes that the LTE-LAA UE supports WiFi access to the base station which can be expected since most of current UEs are equipped with both LTE and WiFi modems.

At the LTE subframe start time, the UE stops the WiFi transmission 1407 and starts an LTE reception/transmission 1409 in the unlicensed band and the base station accordingly performs LTE transmission/reception 1410 in unlicensed band (to form an uplink or downlink LTE communication between the base station and the UE in the unlicensed band). In parallel, the base station may perform an LTE transmission/reception 1411 in the licensed band and the UE may accordingly perform LTE reception/transmission 1412 in the licensed band (to form an uplink or downlink LTE communication between the base station and the UE in the licensed band). The WiFi transmission 1407 may include an indication of the length of the WiFi transmission 1407 that includes the duration tₐ of the LTE reception/transmission in unlicensed band 1409 such that the WiFi devices consider the channel to be occupied until the end of the LTE reception/transmission in unlicensed band 1409.

It should be noted that in SAS, the CCA 1306, 1406 and the WiFi transmission 1307, 1407 may be triggered by the SAS entities 501 as illustrated in FIG. 5 since those are responsible for interference management. For example, they could task a corresponding base station or UE to transmit a corresponding signal (or perform a corresponding action). The same applies to other actions by the base station and the UE.

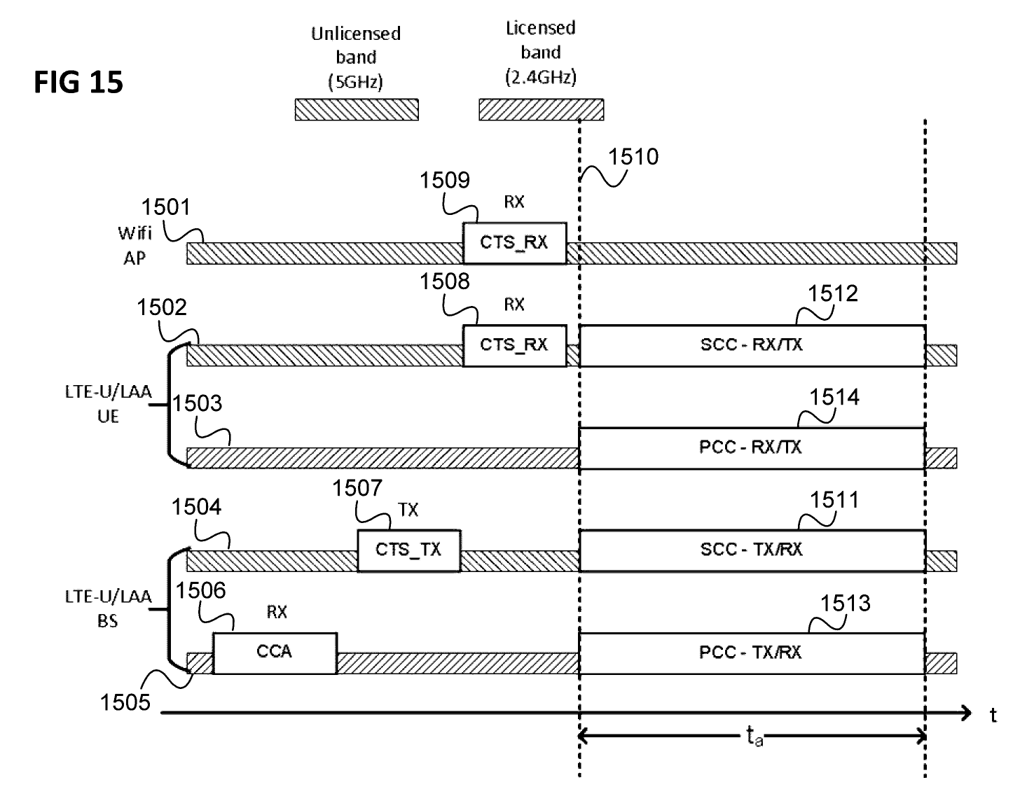

FIG. 15 illustrates a coexistence mechanism which is based on a clear channel assessment (CCA) and a CTS by the base station.

Similarly to FIG. 13, time flows from left to right in FIG. 15. FIG. 15 shows a first representation of the unlicensed band 1501 for illustrating usage of the unlicensed band by a WiFi access point (AP) and one or more WiFi nodes, a second representation of the unlicensed band 1502 for illustrating usage of the unlicensed band by a UE, a first representation of a licensed band 1503 for illustrating usage of the licensed band by the UE, a third representation of the unlicensed band 1504 for illustrating usage of the unlicensed band by the base station and a second representation of the licensed band 1505 (MNO band) for illustrating usage of the licensed band by the base station.

The base station performs a sensing (CCA) 1506 of the unlicensed band. If the channel is clear, as assumed in this example, the base station performs a CTS transmission 1507 (i.e. sends a CTS message). Accordingly, the UE performs a CTS reception 1508 and the WiFi devices (WiFi AP and WiFi nodes) perform a CTS reception 1509 (i.e. receive the CTS message).

At the LTE subframe start time 1510, the base station starts an LTE transmission/reception 1511 in the unlicensed band and the UE accordingly performs LTE reception/transmission 1512 in unlicensed band. In parallel, the base station may perform an LTE transmission/reception 1513 in the licensed band and the UE may accordingly perform LTE reception/transmission 1514 in the licensed band.

Since after CTS reception, the WiFi devices consider the channel as occupied there is no interference from the WiFi devices to the LTE transmission/reception 1511 in unlicensed band.

The CTS transmitted by the base station in 1507 may be a dummy CTS, i.e. it may be a CTS message that is not addressed to the UE and the WiFi devices, but for example is addressed to an unassigned address.

The CTS message may include an indication of a following WiFi transmission that includes the duration tₐ of the LTE transmission/reception 1511 in unlicensed band.

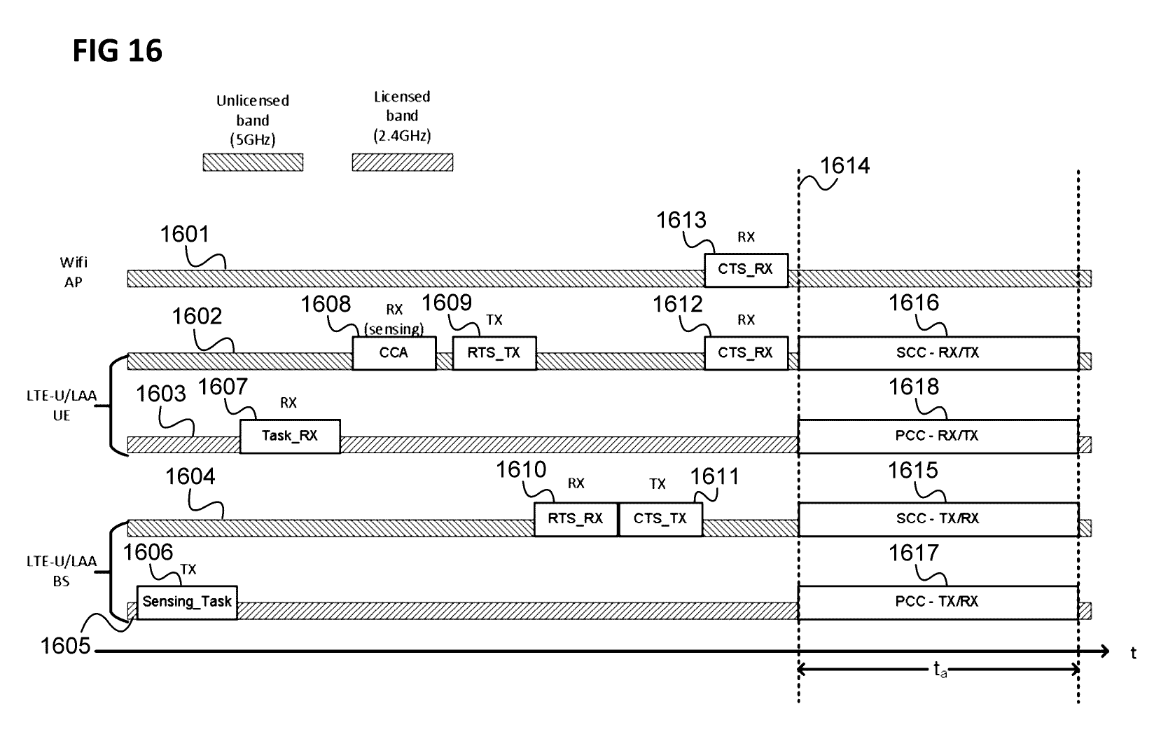

FIG. 16 illustrates a coexistence mechanism which is based on a clear channel assessment (CCA) and a RTS by the UE (after assignment by the base station) followed by a CTS by the base station.

Similarly to FIG. 13, time flows from left to right in FIG. 16. FIG. 16 shows a first representation of the unlicensed band 1601 for illustrating usage of the unlicensed band by a WiFi access point (AP) and one or more WiFi nodes, a second representation of the unlicensed band 1602 for illustrating usage of the unlicensed band by a UE, a first representation of a licensed band 1603 for illustrating usage of the licensed band by the UE, a third representation of the unlicensed band 1604 for illustrating usage of the unlicensed band by the base station and a second representation of the licensed band 1605 (MNO band) for illustrating usage of the licensed band by the base station.

In this example, the base station assigns the sensing task to the UE because UEs are distributed in different geolocations and have more visibility. For this, the base station sends, over the licensed band, a sensing task message 1606 to the UE to request the UE to start CCA in the WiFi band or a specific WiFi channel. The base station then knows when to wait for RTS from UE. For the sensing task message, an indication may for example be defined for the downlink control channel in the LTE standard, e.g. for PDCCH.

In response to the reception of the sensing task message 1607 the UE performs a sensing (CCA) 1608 of the unlicensed band. If the channel is clear, as assumed in this example, the UE performs a RTS transmission 1609 (i.e. sends an RTS message). Accordingly, the base station performs a RTS reception 1610 (i.e. receives the RTS message). In response to the RTS, the base station performs a CTS transmission 1611. Accordingly, the UE performs a CTS reception 1612 and the WiFi devices (WiFi AP and WiFi nodes) perform a CTS reception 1613.

At the LTE subframe start time 1614, the base station starts an LTE transmission/reception 1615 in the unlicensed band and the UE accordingly performs LTE reception/transmission 1616 in unlicensed band. In parallel, the base station may perform an LTE transmission/reception 1617 in the licensed band and the UE may accordingly perform LTE reception/transmission 1618 in the licensed band.

Since after CTS reception, the WiFi devices consider the channel as occupied there is no interference from the WiFi devices to the LTE transmission/reception 1615 in unlicensed band.

The CTS transmitted by the base station in 1611 may be a dummy CTS, i.e. it may be a CTS message that is not addressed to the UE and the WiFi devices, but for example includes an unassigned address.

The CTS message may include an indication of a following WiFi transmission that includes the duration tₐ of the LTE transmission/reception 1609 in unlicensed band.

Generally, for a first LTE-U/LTE-LAA and a second LTE-U/LTE-LAA device (one being the base station and one the UE in the examples of FIGS. 15 and 16, e.g. corresponding to the communication device and the second communication device in the context of FIG. 8), the first device performs CCA, then there may be a small silence period, then the first device sends the RTS sequence, then there may be a small silence period, then the second device receives the RTS sequence, then there may be a small silence period, then the 2^{nd} device sends the CTS sequence, then there may be a small silence period, then the first device receives the CTS sequence, then there may be a small silence period or not, then data communication starts.

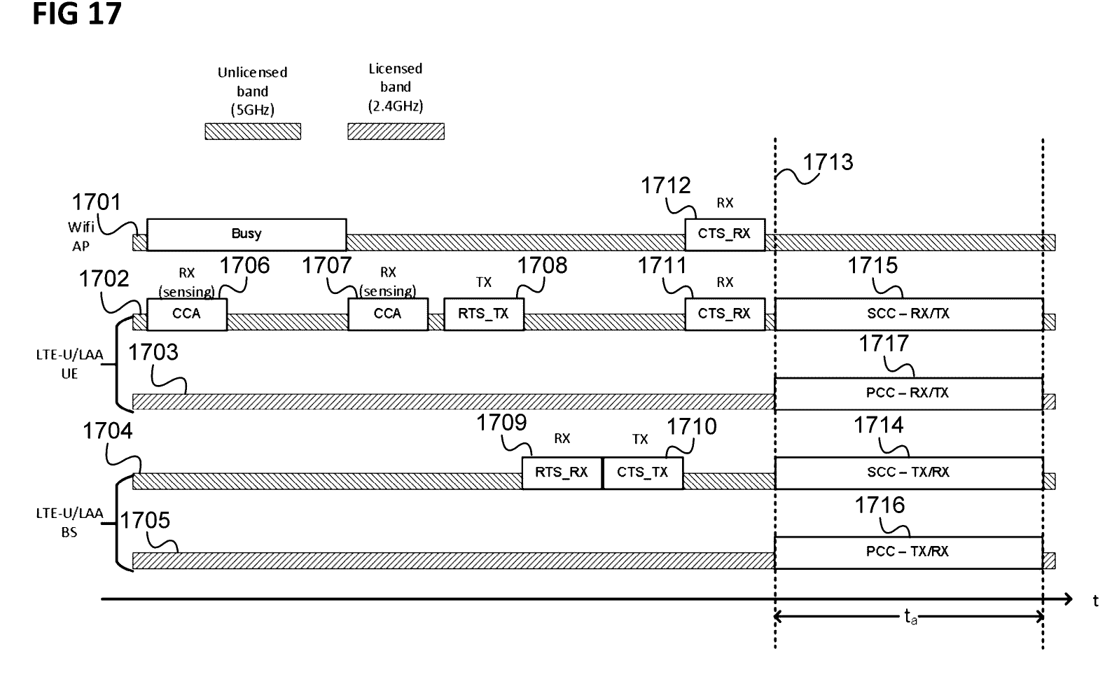

FIG. 17 illustrates a coexistence mechanism which is based on a clear channel assessment (CCA) and a RTS by the UE followed by a CTS by the base station.

Similarly to FIG. 13, time flows from left to right in FIG. 17. FIG. 17 shows a first representation of the unlicensed band 1701 for illustrating usage of the unlicensed band by a WiFi access point (AP) and one or more WiFi nodes, a second representation of the unlicensed band 1702 for illustrating usage of the unlicensed band by a UE, a first representation of a licensed band 1703 for illustrating usage of the licensed band by the UE, a third representation of the unlicensed band 1704 for illustrating usage of the unlicensed band by the base station and a second representation of the licensed band 1705 (MNO band) for illustrating usage of the licensed band by the base station.

In contrast to the mechanism of FIG. 16, in this example, the UE automatically (or permanently) listens to the WiFi band, i.e. without being instructed by the base station to do this. Accordingly, this mechanism may be implemented without modification of the LTE standard.

The UE performs a sensing (CCA) 1706, 1707 of the unlicensed band. In this example, it is assumed that the WiFi channel is occupied (busy) at the time of a first sensing 1706 but is unoccupied at the time of a second sensing 1707.

When the channel is clear (i.e. unoccupied), the UE performs a RTS transmission 1708. Accordingly, the base station performs a RTS reception 1709. In response to the RTS, the base station performs a CTS transmission 1710. Accordingly, the UE performs a CTS reception 1711 and the WiFi devices (WiFi AP and WiFi nodes) perform a CTS reception 1712.

At the LTE subframe start time 1713, the base station starts an LTE transmission/reception 1714 in the unlicensed band and the UE accordingly performs LTE reception/transmission 1715 in unlicensed band. In parallel, the base station may perform an LTE transmission/reception 1716 in the licensed band and the UE may accordingly perform LTE reception/transmission 1717 in the licensed band.

Since after CTS reception, the WiFi devices consider the channel as occupied there is no interference from the WiFi devices to the LTE transmission/reception 1714 in unlicensed band.

The CTS transmitted by the base station in 1711 may be a dummy CTS, i.e. it may be a CTS message that is not addressed to the UE and the WiFi devices, but for example includes an unassigned address.

The CTS message may include an indication of a following WiFi transmission that includes the duration tₐ of the LTE transmission/reception 1709 in unlicensed band.

With the mechanisms described with reference to FIGS. 15 to 17, collisions between LTE-U and WiFi Nodes can be avoided. From a WiFi network point of view, the LTE communication network is a WiFi node in another WiFi network.

It should be noted that in a hierarchical architecture for an LSA system, the upper approaches can be considered regarding a local vs. a regional control. Policies may be issued from a regional controller (with large time constants) while the implementation of the specific sharing mechanisms may finally be done by a local controller (with smaller time constants).

For this approach an overload indicator may be introduced which triggers neighboring local controllers (e.g. similar to HSUPA where devices decode a neighbor grant in order to reduce the interference to a neighbor cell). Such a grant (or interference-control indicator) could be exchanged between neighboring local controllers. This could be done through the regional controller or alternatively through direct links or through the devices themselves (e.g. similar to HSUPA).

While specific aspects have been described, it should be understood by those skilled in the art that various changes in form and detail may be made therein without departing from the spirit and scope of the aspects of this disclosure as defined by the appended claims. The scope is thus indicated by the appended claims and all changes which come within the meaning and range of equivalency of the claims are therefore intended to be embraced.

1. A communication device comprising:
a transceiver configured for communication according to a wide area network radio access technology and configured for communication according to a local area network radio access technology;
a detector configured to detect whether a frequency range is unoccupied; and
a controller configured
to control the transceiver to, if the frequency range is unoccupied, transmit data according to the local area network radio access technology to occupy the frequency range until a communication starting time according to a frame structure of the wide area network radio access technology; and
to control the transceiver to start communication using the frequency range according to the wide area network radio access technology at the communication starting time.

2. The communication device of claim 1, wherein the communication starting time is a frame or subframe starting time according to a frame structure of the wide area network radio access technology.

3. The communication device of claim 1, wherein the wide area network radio access technology is Long Term Evolution (LTE).

4. The communication device of claim 3, wherein the wide area network radio access technology is LTE for unlicensed band usage.

5. The communication device of claim 3, wherein the controller is configured to control the transceiver to start communication using the frequency range according to LTE-Unlicensed at the communication starting time.

6. The communication device of claim 3, wherein the communication starting time is an LTE subframe.

7. The communication device of claim 1, wherein the local area network radio access technology is WiFi.

8. The communication device of claim 1, wherein the data transmitted with the transmission of data according to the local area network radio access technology include an indication of a length of usage of the frequency range by the communication device.

9. The communication device of claim 8, wherein the length of usage of the frequency range by the communication device includes the duration of the communication using the frequency range according to the wide area network radio access technology.

10. The communication device of claim 1, wherein the transmission of data according to the wide area network radio access technology is a transmission of data to a second communication device.

11. The communication device of claim 10, wherein the communication using the frequency range according to the wide area network radio access technology is a communication with the second communication device.

12. The communication device of claim 10, wherein the data transmitted with the transmission of data according to the local area network radio access technology include useful data to be transmitted to the second communication device.

13. The communication device of claim 12, wherein the transmission of data according to the local area network radio access technology includes a transmission of a first part of a data stream and the communication using the frequency range according to the wide area network radio access technology includes a transmission of a second part of the data stream.

14. The communication device of claim 10, wherein the communication device is a base station and the second communication device is a subscriber terminal or wherein the communication device is a subscriber terminal and the second communication device is a base station.

15. The communication device of claim 1, wherein the frequency range corresponds to a frequency channel of the local area network radio access technology.

16. The communication device of claim 1, wherein the transceiver comprises a first modem for communication according to the wide area network radio access technology and comprises a second modem for communication according to a local area network radio access technology.

17. The communication device of claim 1, wherein the communication device is a base station or a communication terminal.

18. A method for communicating using a frequency range comprising
detecting whether a frequency range is unoccupied;
transmitting data according to a local area network radio access technology to occupy the frequency range until a communication starting time according to a frame structure of a wide area network radio access technology if the frequency range is unoccupied; and
starting communication using the frequency range according to the wide area network radio access technology at the communication starting time.

19. A communication device comprising:
a transceiver configured for communication according to a first radio access technology and configured for communication according to a second radio access technology; and
a controller configured to control the transceiver to
send a reservation message in a frequency range according to the second radio access technology for reserving a frequency range in the radio communication band for communication by the communication device for a predetermined time interval; and
transmit data to a second communication device and to receive data from the second communication device according to the first radio access technology during the time interval.

20. A communication device comprising:
a first transceiver configured to communicate using a first frequency range outside of the unlicensed industrial, scientific, and medical (ISM) band and to communicate using a second frequency range in the ISM band;
a detector configured to detect that a second transceiver of a second communication device has initiated or is about to initiate usage of the first frequency range and that the second transceiver has a higher priority for usage of the first frequency range than the first transceiver; and
a controller configured to control the first transceiver to perform a communication using the second frequency range in the ISM band in response to the detection that the second transceiver has initiated or is about to initiate usage of the first frequency range.
